(19) United States
(12) Patent Application Publication
(10) Pub. No.: US 2010/0039202 A1
(43) Pub. Date: Feb. 18, 2010

(54) MAGNETIC ELEMENT

(75) Inventors: Hsin-Wei Tsai, Taoyuan Hsien (TW); Shih-Hsien Chang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/323,289

(22) Filed: Nov. 25, 2008

(30) Foreign Application Priority Data
Aug. 18, 2008 (TW) 097131420

(51) Int. Cl. H01F 17/06

(52) U.S. Cl. 336/178

(57) ABSTRACT

A magnetic element includes a conducting winding structure, first and second magnetic parts, and first and second side posts. The first and second magnetic parts have first and second central posts that are aligned with each other. The first side post is disposed on an edge of the first or second magnetic part. The second side post is disposed on another edge of the first or second magnetic part where no side post is disposed or the first side post is not aligned with. The conducting winding structure is sandwiched between the first and second magnetic parts. The first and second side posts are aligned with corresponding edges wherein no side post is disposed. Consequently, the overall height of the first and second central post is less than the height of the first or second side post and an air gap is defined between the first and second central post.

### FIELD OF THE INVENTION

The present invention relates to a magnetic element, and more particularly to a magnetic element that is small-sized and easily assembled.

### BACKGROUND OF THE INVENTION

Nowadays, magnetic elements such as inductors and transformers are widely used in many electronic devices to generate induced magnetic fluxes. Recently, since the electronic devices are developed toward minimization, the electronic components contained in the electronic products become small in size and light in weight. Therefore, the magnetic element and its conductive winding module are slim.

Take an inductor for example. FIG. 1A is a schematic exploded view of a conventional inductor. The inductor 1 principally comprises a bobbin 11, a magnetic core assembly 12 and a coil 13. The bobbin 11 has a winding section 111 for winding the coil 13 thereon. The bobbin 11 further has a channel 112 running through a center portion thereof. In addition, the bobbin 11 has several pins 113 extended from the bottom surface thereof and connected to the coil 13. By soldering the pins 113 on a circuit board (not shown), the inductor 1 is mounted on and electrically connected to the circuit board. The magnetic core assembly 12 includes a first magnetic part 121 and a second magnetic part 122. The first magnetic part 121 has a central post 121a and two side posts 121b. The second magnetic part 122 also has a central post 122a and two side posts 122b. As such, the first magnetic part 121 and the second magnetic part 122 of the magnetic core assembly 12 are cooperatively formed as an EE-type core assembly.

For assembling the inductor 1, the central post 121a of the first magnetic part 121 and the central post 122a of the second magnetic part 122 are aligned with the channel 112 and embedded into the channel 112. In addition, the side posts 121b of the first magnetic part 121 are contacted with the side posts 122b of the second magnetic part 122. As such, the coils 13 will interact with the magnetic core assembly 12 to achieve the function of inductor. The resulting structure of the assembled inductor 1 is schematically shown in FIG. 1B.

For controlling inductance of the inductor 1, the distance between the central post 121a of the first magnetic part 121 and the central post 122a of the second magnetic part 122 should be adjusted such that the air gap of the inductor 1 is changed. For achieving the purpose, portions of the central posts 121a and 122a are scraped by a tool such that central post 121a/122a is shorter than the side post 122a/122b by d₀ (as shown in FIG. 1A). Under this circumstance, after the central post 121a of the first magnetic part 121 and the central post 122a of the second magnetic part 122 are embedded into the channel 112, the central post 121a is distant from the central post 122a by a gap of 2×d₀. Due to the gap, the inductance of the inductor 1 is adjusted.

The process of fabricating the inductor 1 has some drawbacks. For example, since the side posts 122a and 122b are disposed at bilateral sides of the central posts 121a and 122a, the side posts 122a and 122b become hindrance from scraping the central posts 121a and 122a. Especially when a longer gap is required, the process of scraping the central posts 121a and 122a is time consuming and complicated. In addition, since the side posts 121b of the first magnetic part 121 are contacted with the side posts 122b of the second magnetic part 122, the volume of the inductor 1 is very bulky.

Therefore, there is a need of providing an improved magnetic element so as to obviate the drawbacks encountered from the prior art.

### SUMMARY OF THE INVENTION

An object of the present invention provides a magnetic element having increased air gap between two central posts of the magnetic core assembly so as to adjust the inductance of the magnetic element.

Another object of the present invention provides a magnetic element having reduced volume.

A further object of the present invention provides a magnetic element whose central posts are easily scraped off without being hindered by the side posts, thereby reducing fabricating time and cost.

In accordance with an aspect of the present invention, there is provided a magnetic element. The magnetic element includes a conducting winding structure, a first magnetic part, a second magnetic part, a first side post and a second side post. The first magnetic part has a first central post. The second magnetic part has a second central post. The first side post is disposed on an edge of the first magnetic part or the second magnetic part. The second side post is disposed on another edge of the first magnetic part or the second magnetic part where no side post is disposed or the first side post is not aligned with. The conducting winding structure is sandwiched between the first magnetic part and the second magnetic part. The first central post is aligned with the second central post. The first and second side posts are aligned with corresponding edges wherein no side post is disposed. As a result, the overall height of the first central post and the second central post is less than the height of the first side post or the second side post and an air gap is defined between the first central post and the second central post.

In accordance with another aspect of the present invention, there is provided a magnetic element. The magnetic element includes a conducting winding structure, a first magnetic part and a second magnetic part. The first magnetic part has a first central post and multiple side posts. The second magnetic part has a second central post and multiple edges. The conducting winding structure is sandwiched between the first magnetic part and the second magnetic part. The first central post is aligned with the second central post. The side posts of the first magnetic part are aligned with corresponding edges of the second magnetic part wherein no side post is disposed. As a result, the overall height of the first central post and the second central post is less than the height of the side post and an air gap is defined between the first central post and the second central post.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic exploded view of a conventional inductor;

FIG. 1B is a schematic assembled view of a conventional inductor;

FIG. 2A is a schematic exploded view illustrating a magnetic element according to a first preferred embodiment of the present invention;

FIG. 2B is a schematic assembled view of the magnetic element shown in FIG. 2A;

FIG. 3 is a schematic exploded view illustrating a magnetic core assembly used in the magnetic element according to a second preferred embodiment of the present invention;

FIG. 4 is a schematic exploded view illustrating a magnetic core assembly used in the magnetic element according to a third preferred embodiment of the present invention;

FIGS. 5A and 5B are schematic exploded views illustrating a magnetic element having the magnetic core assembly shown in FIG. 4 and taken from different viewpoints; and

FIG. 5C is a schematic assembled view of the magnetic element shown in FIG. 5A.

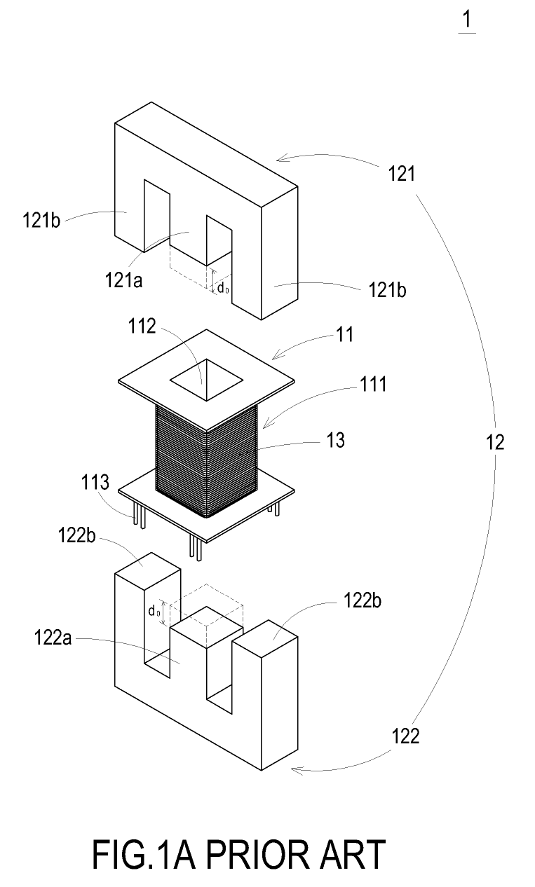

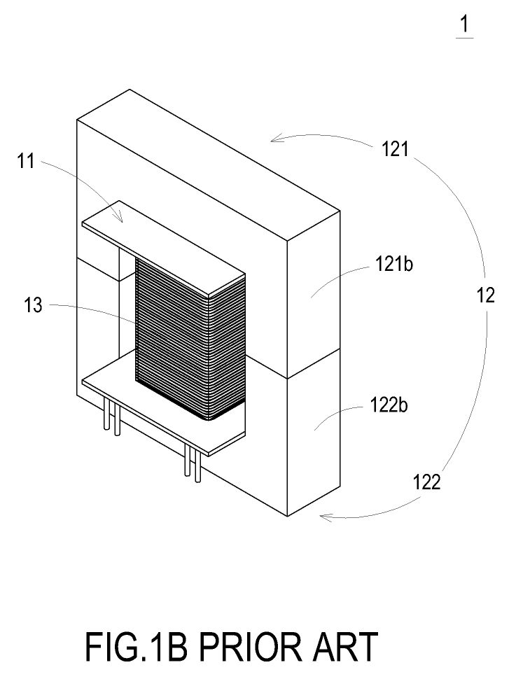

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

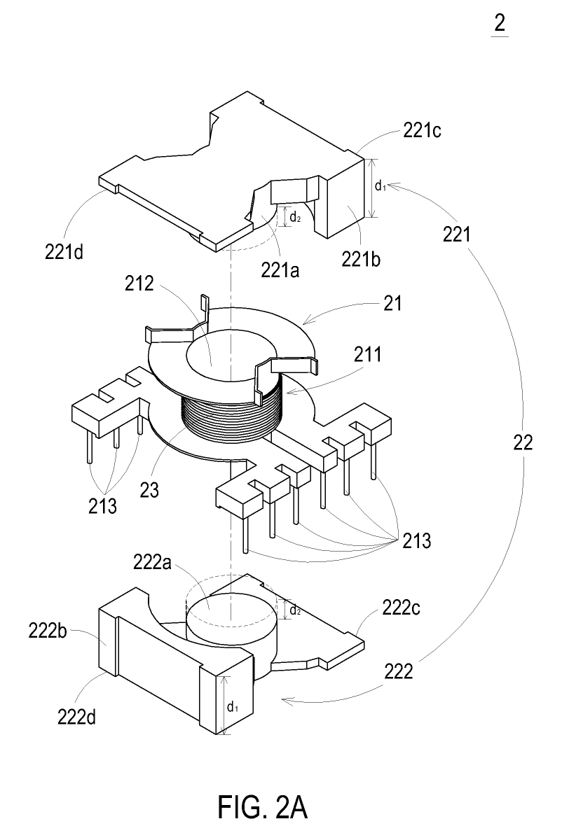

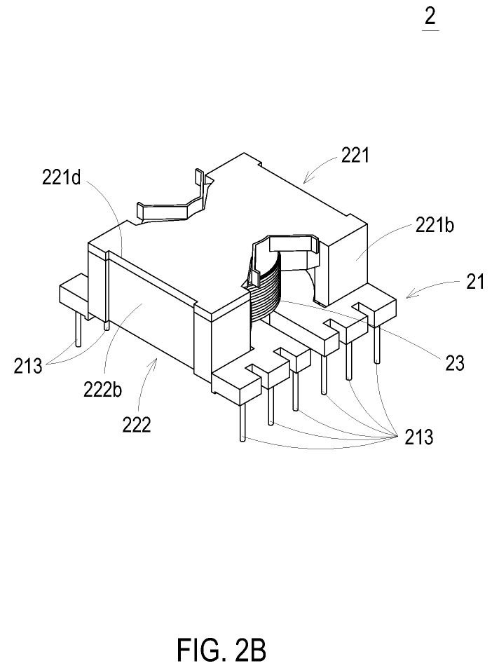

FIG. 2A is a schematic exploded view illustrating a magnetic element according to a first preferred embodiment of the present invention. The magnetic element 2 principally comprises a conductive winding structure and a magnetic core assembly 22. The conductive winding structure includes a bobbin 21 and a coil 23 wound around the bobbin 21. Alternatively, the conductive winding structure is a coil pancake by winding a conductive wire. The bobbin 21 has a winding section 211 for winding the coil 23 thereon. The bobbin 21 further has a channel 212 running through a center portion thereof. In addition, the bobbin 21 has several pins 213 that is extended from the bottom surface thereof and connected to the coil 23. By soldering the pins 213 on a circuit board (not shown), the magnetic element 2 is mounted on and electrically connected to the circuit board. The circuit board is a system circuit board or an auxiliary circuit board.

The magnetic core assembly 22 includes a first magnetic part 221 and a second magnetic part 222. The first magnetic part 221 has a first central post 221a and a side post 221b. It is preferred that the first central post 221a and the side post 221b are integrally formed on the first magnetic part 221. The side post 221b is disposed on a first edge 221c of the first magnetic part 221 and aligned with a first edge 222c of the second magnetic part 222. The first central post 221a is shorter than the side post 221b by a length d₂. The second magnetic part 222 has a second central post 222a and a side post 222b. It is preferred that the second central post 222a and the side post 222b are integrally formed on the second magnetic part 222. The side post 222b of the second magnetic part 222 is disposed on a second edge 222d and aligned with a second edge 221d of the first magnetic part 221. Likewise, the second central post 222a is shorter than the side post 222b by a length d₂. In addition, the height of the side post 221b of the first magnetic part 221 is equal to the height of the side post 222b of the second magnetic part 222 (=d₁).

Please refer to FIGS. 2A and 2B. For assembling the magnetic element 2, the central post 221a of the first magnetic part 221 and the central post 222a of the second magnetic part 222 are aligned with the channel 212 and embedded into the channel 212. In addition, the side post 221b of the first magnetic part 221 is contacted with the first edge 222c of the second magnetic part 222; and the side post 222b of the second magnetic part 222 is contacted with the second edge 221d of the first magnetic part 221. As such, the coils 23 on the bobbin 21 will interact with the first magnetic part 221 and the second magnetic part 222 of the magnetic core assembly 22 to achieve the purpose of voltage regulation. The resulting structure of the assembled magnetic element 2 is schematically shown in FIG. 2B.

After the first central post 221a of the first magnetic part 221 and the second central post 222a of the second magnetic part 222 are embedded into the channel 212 of the bobbin 21, the first central post 221a is distant from the second central post 222a by an air gap. Due to the air gap, the inductance of the magnetic element 2 is increased. Since the side posts 221b and 222b are respectively disposed on the first edge 222c and second edge 221d where no side post is disposed, the overall thickness of the assembled magnetic element 2 is substantially equal to the height d₁ of the side post 221b or 222b. In comparison with the conventional inductor, the magnetic element 2 of the present invention is very slim in thickness and thus the overall volume of the magnetic element 2 is largely reduced. Moreover, the inductance of the magnetic element 2 is adjustable by changing the air gap between the first central post 221a and the second central post 222a. Generally, as the air gap is increased, the inductance of the magnetic element 2 is reduced.

Since no side post is disposed on the second edge 221d of the first magnetic part 221, a portion of the first central post 221a may be scraped off by moving the scraping tool forwardly and backwardly through the second edge 221d. Similarly, since no side post is disposed on the first edge 222c of the second magnetic part 222, a portion of the second central post 222a may be scraped off by moving the scraping tool forwardly and backwardly through the first edge 222c. As a consequence, the processes of scraping the first central post 221a and the second central post 222a are simplified and time-saving.

An example of the magnetic element 2 includes but is not limited to an inductor or a transformer. In a case that the magnetic element 2 is a transformer, the magnetic element 2 further includes a secondary winding coil (not shown). As such, the conductive winding structure and the secondary winding coil interact with the magnetic core assembly 22 to achieve the purpose of voltage regulation.

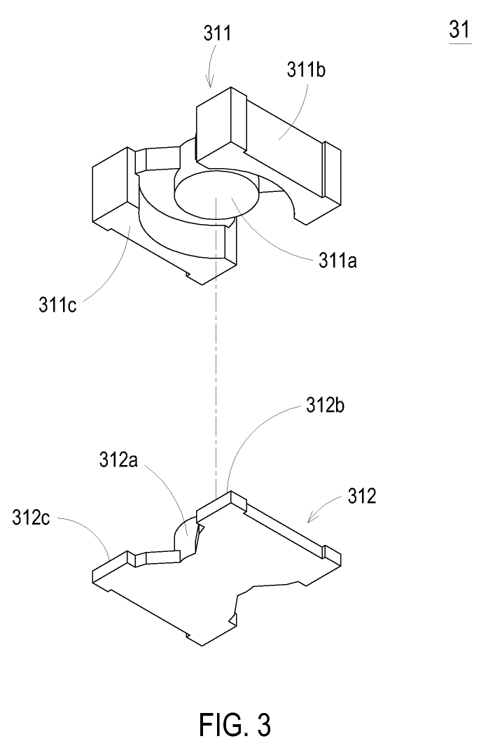

FIG. 3 is a schematic exploded view illustrating a magnetic core assembly used in the magnetic element according to a second preferred embodiment of the present invention. The magnetic core assembly 31 includes a first magnetic part 311 and a second magnetic part 312. The first magnetic part 311 has a first central post 311a, a first side post 311b and a second side post 311c. The height of the first side post 311b is equal to the height of the second side post 311c. The second magnetic part 312 has a second central post 312a. The second magnetic part 312 has a first edge 312b and a second edge 312c corresponding to the first side post 311b and the second side post 311c of the first magnetic part 311, respectively. The overall height of the first central post 311a and the second central post 312a is less than the height of the first side post 311b or the second side post 311c. After the first central post 311a of the first magnetic part 311 and the second central post 312a of the second magnetic part 312 are embedded into the channel of the bobbin (as shown in FIG. 2A), the first central post 311a is distant from the second central post 312a by an air gap (not shown). In addition, the first side post 311b and the second side post 311c of the first magnetic part 311 are contacted with the first edge 312b and the second edge 312c, respectively. The overall thickness of the assembled magnetic core assembly 31 is substantially equal to the height of the first side post 311b plus the thickness of the first edge 312b (or the height of the second side post 311c plus the thickness of the second edge 312c). In comparison with the conventional inductor, the magnetic core assembly 31 of the present invention is very slim in thickness and thus the overall volume of the magnetic element is largely reduced. Moreover, the inductance of the magnetic element is adjustable by changing the air gap between the first central post 311a and the second central post 312a.

In the above embodiments, the locations of the side posts of the magnetic core assembly are not restricted as long as the side posts are contacted with edges of the first magnetic part and/or the second magnetic part where no side post is disposed and the overall volume of the magnetic element is reduced.

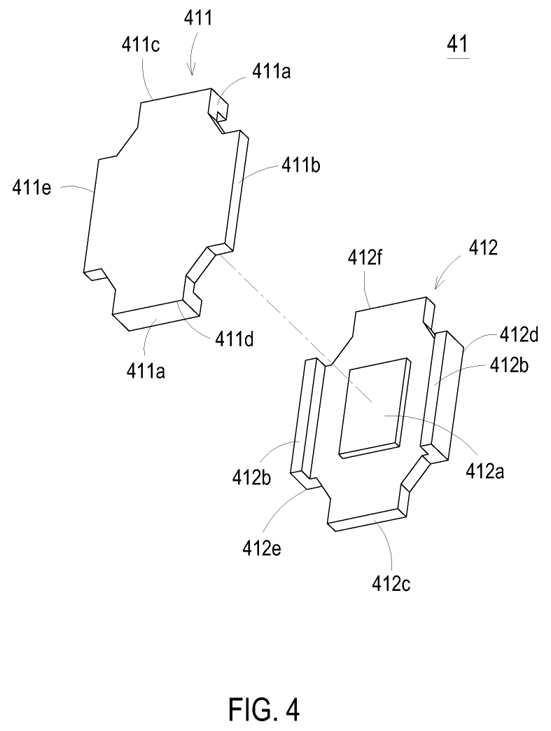

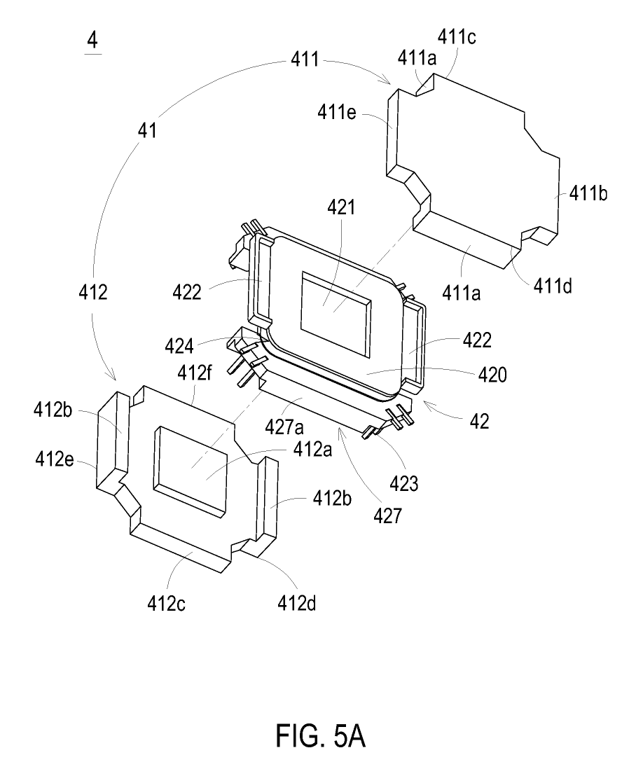

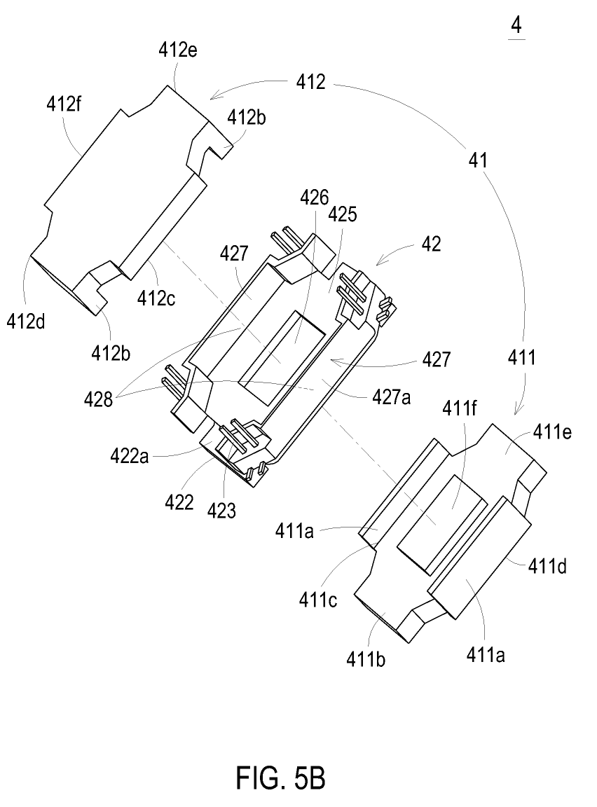

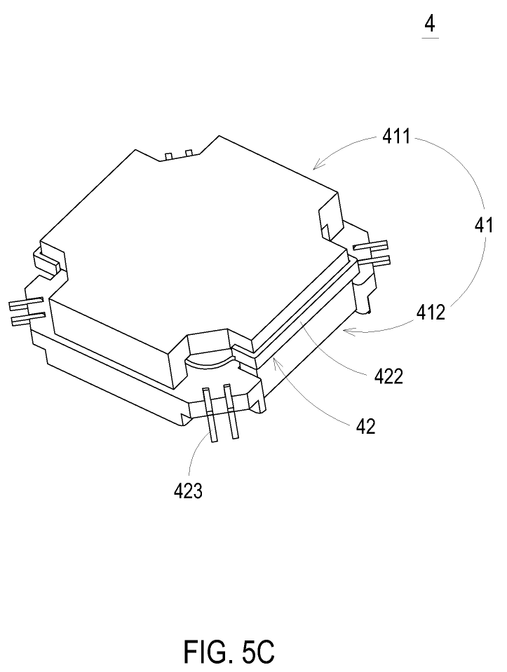

FIG. 4 is a schematic exploded view illustrating a magnetic core assembly used in the magnetic element according to a third preferred embodiment of the present invention. The magnetic core assembly 41 includes a first magnetic part 411 and a second magnetic part 412. The first magnetic part 411 and the second magnetic part 412 substantially have rectangular profiles. The first magnetic part 411 comprises a first central post 411f (as shown in FIG. 5B), two side posts 411a and four edges 411b, 411c, 411d and 411e. The side posts 411a are disposed on two opposite edges 411c and 411d. Alternatively, the side posts 411a are disposed on the two adjacent edges. No side post is disposed on the other two edges 411b and 411e. The second magnetic part 412 comprises a second central post 412a, two side posts 412b and four edges 412c, 412d, 412e and 412f. The two side posts 412b are disposed on two opposite edges 412d and 412e, which are respectively aligned with the edges 411b and 411e of the first magnetic part 411. The height of the side post 411a of the first magnetic part 411 is substantially equal to the height of the side post 412b of the second magnetic part 412. At least one of the first central post 411f and the second central post 412a is shorter than the side posts 411a and 412b. In addition, the overall height of the first central post 411f and the second central post 412a is less than the height of the side post 411a or 412b. After the first central post 411f of the first magnetic part 411 and the second central post 412a of the second magnetic part 412 are embedded into the channel of the bobbin (as shown in FIG. 2), the first central post 411f is distant from the second central post 412a by an air gap (not shown). In addition, the side posts 411a and 412b are contacted with the edges 412c, 412f, 411b and 411e, respectively. The overall thickness of the assembled magnetic core assembly 41 is substantially equal to the height of the side post (411a or 412b) plus the thickness of one of the edges 412c, 412f, 411b and 411e. In comparison with the conventional inductor, the magnetic core assembly 41 of the present invention is very slim in thickness and thus the overall volume of the magnetic element is largely reduced. Moreover, the inductance of the magnetic element is adjustable by changing the air gap between the first central post 411f and the second central post 412a. Moreover, since no side post is disposed on the edges 411b, 411e, 412c and 412f, portions of the central posts 411f and 412a may be scraped off by moving the scraping tool forwardly and backwardly through the edges 411b, 411e, 412c and 412f. As a consequence, the processes of scraping the central posts 411f and 412a are simplified and time-saving.

FIGS. 5A and 5B are schematic exploded views illustrating a magnetic element having the magnetic core assembly shown in FIG. 4 and taken from different viewpoints. The magnetic element 4 principally comprises a magnetic core assembly 41, a bobbin 42 and a coil (not shown). The bobbin 42 has a winding section 424 for winding the coil thereon. The bobbin 42 has a first surface 420 and a second surface 425. A first receiving portion 421 is formed in the first surface 420 of the bobbin 42 for receiving the first central post 411f therein (as shown in FIG. 5B). A second receiving portion 426 is formed in the second surface 425 of the bobbin 42 for receiving the second central post 412a therein (as shown in FIG. 5B). In addition, two third receiving portions 422 are formed at bilateral sides of the first surface 420 for receiving the edges 411b and 411e of the first magnetic part 411 therein. Two sidewalls 427 are extended downwardly from the other two sides of the bobbin 42. The bobbin 42 further has multiple pins 423, which are disposed on four corners of the rectangular bobbin 42. By soldering the pins 413 on a circuit board (not shown), the magnetic element 4 is mounted on and electrically connected to the circuit board. The circuit board is a system circuit board or an auxiliary circuit board.

Please refer to FIGS. 5A and 5B again. For assembling the magnetic element 4, the first central post 411f of the first magnetic part 411 is embedded into the first receiving portion 421 of the bobbin 42, and the second central post 412a of the second magnetic part 412 is embedded into the second receiving portion 426 of the bobbin 42. As such, the edges 411b and 411e of the first magnetic part 411 are received in the third receiving portions 422 of the bobbin 42, the side posts 411a of the first magnetic part 411 are contacted with the external surfaces 427a of the sidewalls 427 of the bobbin 42, and the side posts 412b of the second magnetic part 412 are sustained against the bottom surfaces of the receiving portions 422 of the bobbin 42. The resulting structure of the assembled magnetic element 4 is schematically shown in FIG. 5C. Next, the magnetic element 4 is clamped by a jig (not shown) and then mounted on a circuit board (not shown) such as a system circuit board or an auxiliary circuit board. Since the first magnetic part 411 and the second magnetic part 412 are separated by the bobbin 42, the first central post 411f of the first magnetic part 411 is distant from the second central post 412a of the second magnetic part 412 by an air gap (not shown). Moreover, the inductance of the magnetic element 4 is adjustable by changing the air gap between the first central post 411f and the second central post 412a. Since the edges 411b and 411e of the first magnetic part 411 are received in the third receiving portions 422 of the bobbin 42 and the edges 412c and 412f of the second magnetic part 412 are received in the fourth receiving portions 428 of the bobbin 42, the first central post 411f is separated from the second central post 412a by the bobbin 42, the side posts 412b of the second magnetic part 412 are separated from the edges 411b and 411c of the first magnetic part 411 by the bobbin 42, and the side posts 411a of the first magnetic part 411 are separated from the edges 412c and 412f of the second magnetic part 412 by the bobbin 42. Under this circumstance, the air gap between the first central post 411f and the second central post 412a is further increased by changing the thickness of the bobbin 42. In other words, only small portions of the first central post 411f and the second central post 412a needs to be scraped off and thus the processes of scraping the central posts 411f and 412a are simplified.

In the above embodiments, the locations of the side posts of the magnetic core assembly may be varied according to the practical requirements. For example, each of the rectangular magnetic parts may have two or more side posts as long as each side post is aligned and contacted with an edge of a corresponding magnetic part where no side post is disposed. Moreover, the rectangular magnetic parts may have arbitrary profiles such as octagonal profiles.

From the above description, the magnetic element of the present invention comprises a conductive winding structure, a first magnetic part and a second magnetic part. Since the side posts of the first magnetic part and the second magnetic part are aligned with the edges of a corresponding magnetic part where no side post is disposed, the overall volume of the magnetic element is largely reduced. Moreover, the inductance of the magnetic element is adjustable by changing the air gap between the first central post of the first magnetic part and the second central post of the second magnetic part. Moreover, the processes of fabricating the first magnetic part and the second magnetic part are simplified and time-consuming in comparison with the prior art. As a consequence, the magnetic element of the present invention is small-sized and easily assembled.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic element comprising:
a conducting winding structure;
a first magnetic part having a first central post;
a second magnetic part having a second central post;
a first side post disposed on an edge of said first magnetic part or said second magnetic part; and
a second side post disposed on another edge of said first magnetic part or said second magnetic part where no side post is disposed or said first side post is not aligned with,
wherein said conducting winding structure is sandwiched between said first magnetic part and said second magnetic part, said first central post is aligned with said second central post, and said first and second side posts are aligned with corresponding edges wherein no side post is disposed, so that the overall height of said first central post and said second central post is less than the height of said first side post or said second side post and an air gap is defined between said first central post and said second central post.

2. The magnetic element according to claim 1 wherein said first central post is integrally formed on said first magnetic part and said second central post is integrally formed on said second magnetic part.

3. The magnetic element according to claim 1 wherein each of said first side post and said second side post is integrally formed on said first magnetic part or said second magnetic part.

4. The magnetic element according to claim 1 wherein said conducting winding structure is a coil pancake.

5. The magnetic element according to claim 1 wherein said conducting winding structure includes a bobbin and a coil wound around said bobbin.

6. The magnetic element according to claim 5 wherein said bobbin comprises a first receiving portion and a second receiving portion for respectively receiving said first central post and said second central post therein.

7. The magnetic element according to claim 6 wherein said bobbin further comprises a third receiving portion and a fourth receiving portion for respectively receiving edges of said first magnetic part and said second magnetic part therein.

8. The magnetic element according to claim 1 wherein said magnetic element is an inductor or a transformer.

9. The magnetic element according to claim 1 wherein said first central post is shorter than each of said first and second side posts.

10. The magnetic element according to claim 1 wherein said second central post is shorter than each of said first and second side posts.

11. A magnetic element comprising:
a conducting winding structure;
a first magnetic part having a first central post and multiple side posts;
a second magnetic part having a second central post and multiple edges;
wherein said conducting winding structure is sandwiched between said first magnetic part and said second magnetic part, said first central post is aligned with said second central post, and said side posts of the first magnetic part are aligned with corresponding edges of said second magnetic part wherein no side post is disposed, so that the overall height of said first central post and said second central post is less than the height of said side post and an air gap is defined between said first central post and said second central post.

12. The magnetic element according to claim 11 wherein said first central post is integrally formed on said first magnetic part and said second central post is integrally formed on said second magnetic part.

13. The magnetic element according to claim 11 wherein said multiple side posts are integrally formed on said first magnetic part.

14. The magnetic element according to claim 11 wherein said conducting winding structure is a coil pancake.

15. The magnetic element according to claim 11 wherein said conducting winding structure includes a bobbin and a coil wound around said bobbin.

16. The magnetic element according to claim 15 wherein said bobbin comprises a first receiving portion and a second receiving portion for respectively receiving said first central post and said second central post therein.

17. The magnetic element according to claim 16 wherein said bobbin further comprises a third receiving portion and a fourth receiving portion for respectively receiving edges of said first magnetic part and said second magnetic part therein.

18. The magnetic element according to claim 11 wherein said magnetic element is an inductor or a transformer.

19. The magnetic element according to claim 11 wherein said first central post is shorter than each of said side posts.

20. The magnetic element according to claim 11 wherein said second central post is shorter than each of said side posts.
